(19) United States
(12) Patent Application Publication
(10) Pub. No.: US 2012/0029990 A1
(43) Pub. Date: Feb. 2, 2012

(54) Social Media Marketing Based on Transactions Using a Mobile Device and Associated Secure Element

(75) Inventor: Michelle Fisher, Oakland, CA (US)

(73) Assignee: Blaze Mobile, Berkeley, CA (US)

(21) Appl. No.: 13/195,055

(22) Filed: Aug. 1, 2011

Related U.S. Application Data
(63) Continuation-in-part of application No. 11/956,261, filed on Dec. 13, 2007.
(60) Provisional application No. 61/447,806, filed on Mar. 1, 2011.

(51) Int. Cl. G06Q 30/02; G06Q 20/32; G06Q 40/02; G06Q 20/16

(52) U.S. Cl. 705/14.19; 705/39; 705/41

(57) ABSTRACT

A secure element can be physically coupled to a mobile communication device to allow for transactions with remote terminals such as point-of-sale and point-of-entry terminals. Data can be transmitted data between the mobile communication device and the secure element in a manner that allows for easy receipt of the data especially in cases where a wireless carrier network or WIFI connection is not available. Once the mobile communication device receives the transaction data, it can be posted on social media sites such as Twitter, Facebook, Myspace, etc . When a consumer shares their latest purchase and opinions about the product or event with their Special Interest Group (e.g. fans on facebook, followers on twitter , or any members affiliated with a social media group), it gives them a voice not available through traditional product review channels, and could compel others to purchase that item as well and merchants can reward users for posting (i.e. marketing) purchase history

### RELATED APPLICATIONS

This application is a continuation in part of U.S. provisional Patent application No. 61/447,807 entitled “Social Media Marketing Based on Transactions Using a Mobile Device and Associated Secure Element” filed on Mar. 1, 2011 which is incorporated in its entirety herein and is a continuation in part of in U.S. patent application Ser. No. 11/956, 261 , titled “Method and System for Delivering Customized Information To A Mobile Communication Device Based on User Affiliations” filed Dec. 13, 2007” which is incorporated herein by reference.

Mobile communication devices—e.g., cellular phones, personal digital assistants, and the like—are increasingly being used to conduct payment transactions as described in U.S. patent application Ser. No. 11/933,351 entitled “Method and System for Purchasing Event Tickets Using a Mobile Communication Device filed Oct. 31, 2007, U.S. patent application Ser. No. 11/933,351, entitled “Method and System For Scheduling A Banking Transaction Through A Mobile Communication Device”, and U.S. patent application Ser. No. 12/592,581, entitled “Method and Apparatus For Completing A Transaction Using A Wireless Mobile Communication Channel and Another Communication Channel filed Nov. 25, 2009, U.S. patent application Ser. No. 13/184,209 entitled “Method and Systems of loading and unloading digital artifacts between a mobile device with an associated secure element and other remote devices” filed Jul. 15, 2011 which claims priority to U.S. Patent Application No. 61/431,077, entitled “Method and Systems of loading and unloading digital between a mobile device with an associated secure element and other remote devices,” filed Feb. 14, 2011, U.S. patent application Ser. No. 11/939,821 entitled “Method and System for Securing Transactions Made Through a Mobile Communication Device” filed Nov. 14, 2007 , and U.S. patent application Ser. No. 11/944,267 entitled “Method And System For Delivering Information To A Mobile Communication Device Based On Consumer Transactions” filed on Nov. 21, 2007 all of which are incorporated herein by reference. Such payment transactions can include, for example, purchasing goods and/or services, tickets, bill payments, and transferring funds between bank accounts. The entire is incorporated herein

### TECHNICAL FIELD

The disclosed embodiments relate generally to wireless communications for a mobile device, and more particularly, to wireless communications between a mobile device and an associated secure element using sound waves.

### BACKGROUND

A secure element can be physically coupled to a mobile communication device to allow for transactions with remote terminals such as point-of-sale and point-of-entry terminals. Data can be transmitted data between the mobile communication device and the secure element in a manner that allows for easy receipt of the data especially in cases where a wireless carrier network or WIFI connection is not available. Once the mobile communication device receives the transaction data, it can be posted on social media sites such as Twitter, Facebook, Myspace, etc . When a consumer shares their latest purchase and opinions about the product or event with their Special Interest Group (e.g. fans on Facebook, followers on twitter, or any members affiliated with a social media group), it gives them a voice not available through traditional product review channels, and could compel others to purchase that item as well. Movie and concert tickets, books and food are just a few examples of purchases your friends would consider making after seeing that you've bought them. This invention also provides merchants with opportunities to reward users not only on making a purchase, but posting the purchase (i.e. marketing) as well as the number of impressions of the post (e.g. followers on twitter, fans on Facebook, etc,) number of previous posts, previous transaction history, location, interests, etc.

### SUMMARY

Disclosed embodiments allow a mobile communication device to communicate non-wirelessly with a secure element that is physically coupled to the mobile communication device. Communications from the mobile communication device to the secure element use a different protocol than communications from the secure element to the mobile communication device.

In some embodiments, a system includes a mobile communication device and a secure element physically coupled to the mobile communication device. The mobile communication device includes a first wireless transceiver, first processor, first memory, first microphone, first speaker, first audio to digital converter(ADC), first battery, and audio port. The secure element includes a second wireless transceiver, second processor, second memory, second microphone, second speaker, a second audio to digital converter (ADC), and an audio cable with 3.55 mm plug that can be inserted into audio port of mobile communication device. The mobile communication device is configured to transmit data via the audio cable connected to the Secure Element. The secure element is configured to transmit data via the audio cable to the mobile communication device

In some embodiments, a method of communicating between a mobile communication device and a secure element physically coupled to the mobile communication device is performed. The mobile communication device includes a first microphone, first wireless transceiver, first processor, and first memory, and the secure element includes a second wireless transceiver, second processor, and second memory. The method includes non-wireless transmission of data between the mobile communication device and the secure element via a cable that connects from the secure element into the audio port of the mobile communication device.

### BRIEF DESCRIPTION OF THE DRAWINGS

FIG. 1 is a block diagram illustrating a communication system in accordance with some embodiments.

FIG. 2 is a block diagram illustrating selected elements of a mobile communication device in accordance with some embodiments.

FIGS. 3A-3C are block diagrams illustrating a secure element to be physically coupled to a mobile communication device in accordance with some embodiments.

FIG. 3D illustrates top and side views of a smart card that can be attached externally to a mobile communication device in accordance with some embodiments.

FIG. 3E illustrates a mobile communication device with a slot for receiving a secure element in accordance with some embodiments.

FIG. 3F illustrates various secure elements coupled to a mobile communication device.

FIG. 4 illustrates a block diagram of a communication system including a mobile communication device and a management server in accordance with one implementation.

FIG. 5 illustrates one implementation of the mobile communication device of FIG. 4

FIG. 6 illustrates one implementation of a method for customizing a mobile application running on a mobile communication device.

FIG. 7 is a block diagram of the social media marketing system

FIG. 8 is a flow chart of the social media marketing system

FIG. 9 illustrates a mobile wallet listing transactions with social media icon next to each transaction

FIG. 10 illustrates a message the mobile wallet creates after the user selects the social media icon

FIG. 11 illustrates a mobile wallet with a movie ticket with a social media icon next to it

FIG. 12 illustrates a message the mobile wallet creates and displays to the user after the user selects the social media option.

FIG. 13 illustrates a Facebook page after the ticket has been posted from the mobile wallet.

FIG. 14 illustrates one implementation of a method for customizing a mobile application with a custom/affiliate logo of a special interest group (SIG).

FIG. 15 illustrates an example custom/advertisement

FIG. 16 is a block diagram of a mobile communication device

FIG. 17 is a block diagram of a secure element

Like reference numerals refer to corresponding parts throughout the drawings.

### DESCRIPTION OF EMBODIMENTS

Reference will now be made in detail to various embodiments, examples of which are illustrated in the accompanying drawings. In the following detailed description, numerous specific details are set forth in order to provide a thorough understanding of the present inventions. However, it will be apparent to one of ordinary skill in the art that the present inventions may be practiced without these specific details. In other instances, well-known methods, procedures, components, and circuits have not been described in detail so as not to unnecessarily obscure aspects of the embodiments.

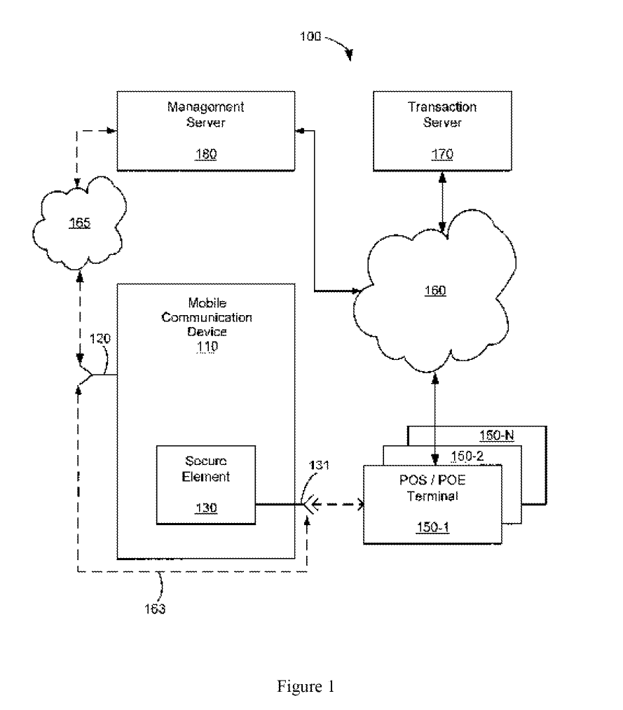

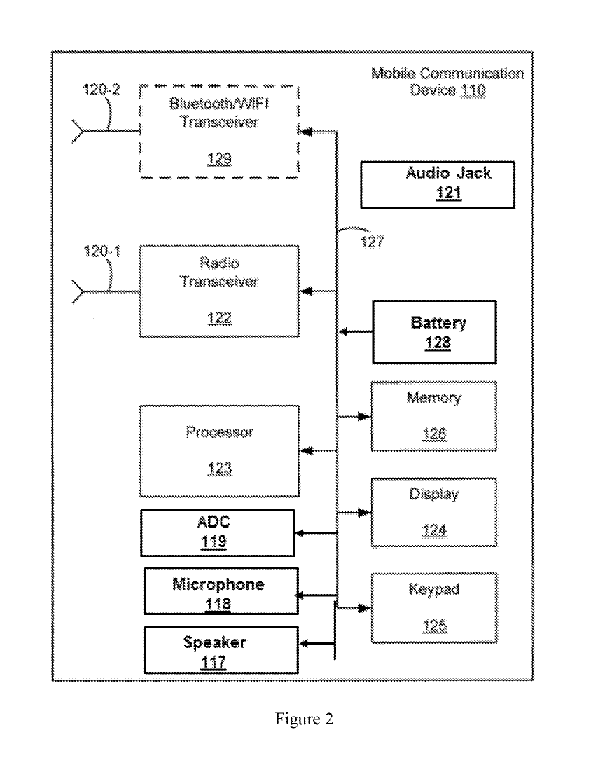

FIG. 1 is a block diagram illustrating a communication system 100 in accordance with some embodiments. The communication system 100 includes a hand-held, wireless mobile communication device 110 with an antenna 120 for wireless communication. While the antenna 120 is shown as extending from the mobile communication device 110 for visual clarity, the antenna 120 may be implemented internally within the mobile communication device 110. Also, the mobile communication device 110 may include more than one antenna 120. The mobile communication device 110 includes a user interface for entering data. For example, a display 124 (FIG. 2) is a touch-screen display; alternatively or in addition, the mobile communication device 110 includes a keypad 125 (FIG. 2) for entering data.

A secure element 130 is physically coupled to the mobile communication device 110. In some embodiments, the secure element 130 is externally attached to the mobile communication device 110. For example, the secure element 130 is adhesively affixed or mechanically secured to the housing of the mobile communication device 110. Alternatively, the secure element 130 is permanently integrated inside the mobile device or housed within a slot located inside the mobile communication device 110. The secure element 130 includes an antenna 131 for wireless communication. While the antenna 131 is shown as extending from the secure element 130 for visual clarity, the antenna 131 may be implemented internally within the secure element 130. Also, the secure element 130 may include more than one antenna 131. Communication occurs wirelessly between the secure element 130 and the mobile communication device 110 via respective antennas 120 and 131, over a direct wireless channel 163 between the mobile communication device 110 and the secure element 130. Thus, in some embodiments, the channel 163 does not pass through a network.

The secure element 130 also can communicate wirelessly with different point-of-sale (POS) or point-of-entry (POE) terminals 150-1 to 150-N via the antenna 131. In some embodiments, a POS terminal 150 receives a transaction request signal from the secure element 130 and transmits the transaction request signal to a transaction server 170 over a network 160. Alternatively, a POE terminal 150 receives an entry request signal from the secure element 130 and transmits the entry request signal to the transaction server 170 over the network 160. The network 160 is any suitable wired and/or wireless network and may include, for example, a local area network (LAN), wide area network (WAN), virtual private network (VPN), the Internet, a metropolitan area network (MAN), or any combination of these or similar networks. The transaction server 170 verifies the request and forwards a verification signal to the management server 180 via the network 160. The management server 180 identifies the user corresponding to the verification signal and provides a response signal back to the mobile communication device 110, which the mobile communication device 110 receives via the antenna 120. The response signal thus is communicated back to the mobile communication device 110 using a communication channel that is different from the communication channel used to initiate the transaction. Alternatively, the response signal is communicated back to the mobile communication device 110 using communication channels from the management server 180 to the secure element 130 through the network 160 and POS terminal 150, and then from the secure element 130 to the mobile communication device 110 via the antennas 131 and 120.

In the example of an entry request signal received at a POE terminal 150, the entry request is verified by the POE terminal 150 or the transaction server 170, upon which the POE terminal 150 admits the user of the mobile communication device 110 to the corresponding venue or facility.

FIG. 2 is a block diagram illustrating selected elements of the mobile communication device 110 in accordance with some embodiments. A processor 123 is coupled to a wireless radio transceiver 122, a display 124, a keypad 125, and a memory 126. The radio transceiver 122 is connected to an antenna 120-1, which is an example of an antenna 120 (FIG. 1) and is adapted to send outgoing voice and data signals and receive incoming voice and data signals over a radio communication channel. The radio communication channel can be a digital radio communication channel (e.g., a cellular channel as provided by a cellular service provider), such as a CDMA or GSM channel Such a radio communication channel has the capacity to communicate both voice and data messages using conventional techniques. In some embodiments, the processor 123 also is coupled to a second wireless transceiver 129 (e.g., a Bluetooth or WiFi transceiver), connected to a corresponding antenna 120-2 (which is another example of an antenna 120, FIG. 1), for communicating with an external device over an additional communication channel separate from the radio communication channel associated with the transceiver 122.

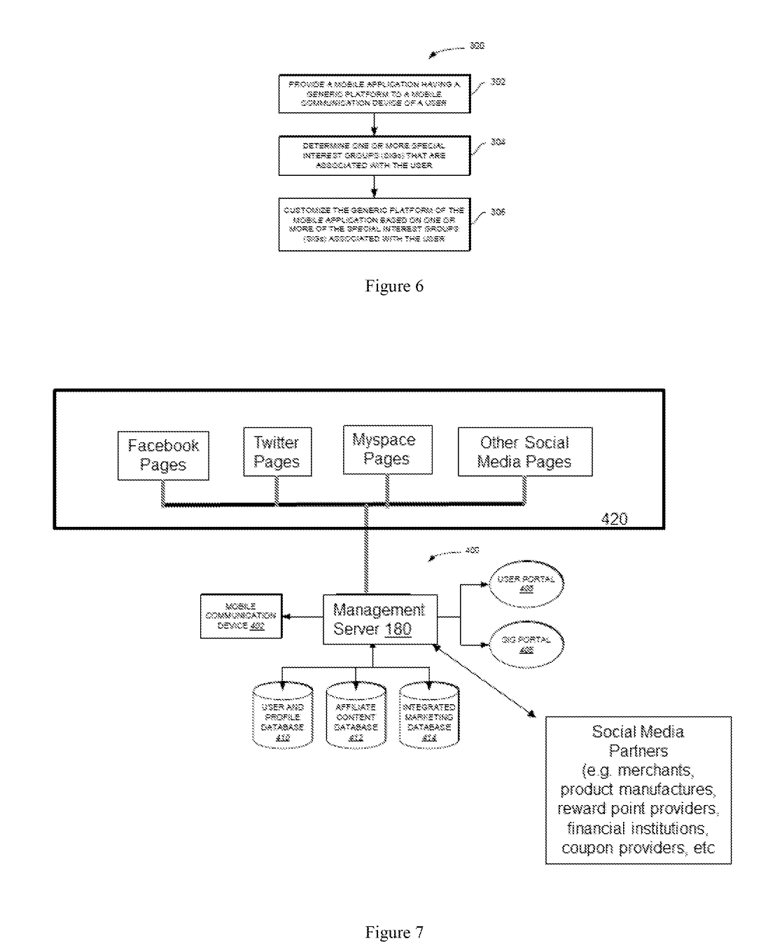

The processor 123 has the capability to perform not only the radio communication services necessary to allow for phone and data communications (e.g., via the transceivers 122 and/or 129), but also to execute various application programs (e.g., applications 620, FIG. 6) that are stored in the memory 126. These application programs can receive inputs from the user via the display 124 and/or keypad 125. In some embodiments, application programs stored in the memory 126 and run on the processor 123 are, for example, iPhone, Android, Windows Mobile, BREW, J2ME, or other mobile applications and can encompass a broad array of application types. Examples of these applications include e-commerce applications 622 (FIG. 6), games 626 (FIG. 6), enterprise applications 628 (FIG. 6), and multimedia applications 630 (FIG. 6). E-commerce applications can include ticketing applications; content, item and service purchase applications; and/or payment management applications. One example of an e-commerce application that runs on the processor 123 and is stored in the memory 126 is an event application that provides event information and ticketing (e.g., for movies, concerts, sports, airplanes, busses, trains, etc). In some implementations, the processor 123 recognizes secure communications (e.g., as received via the transceiver 122 and/or 129) and transmits data from the secure communications to the secure element 130 for storage therein. The processor 123 also processes data received from the secure element 130.

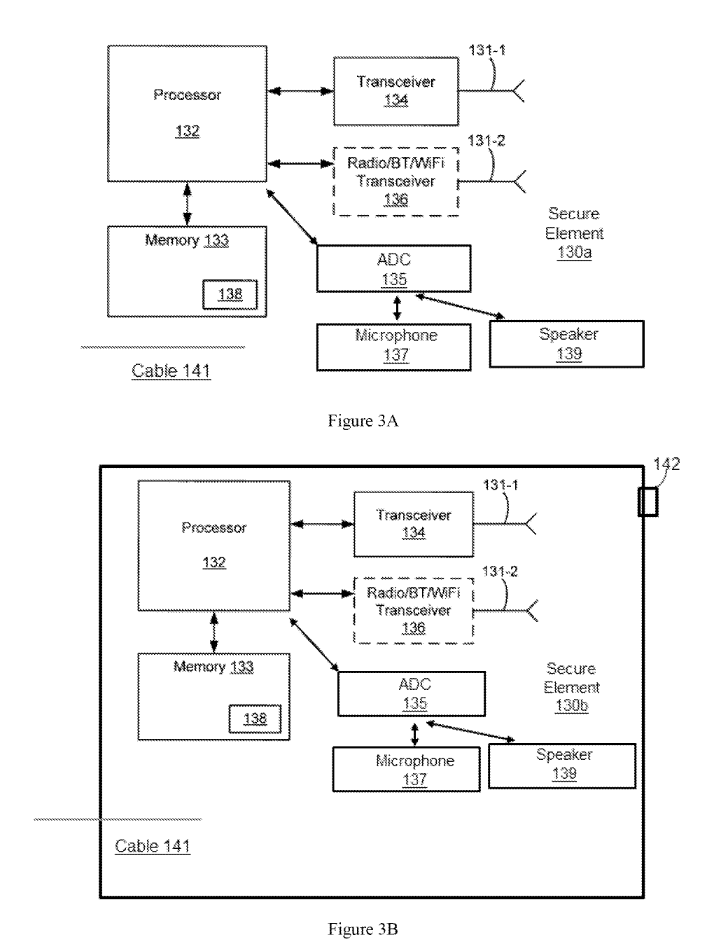

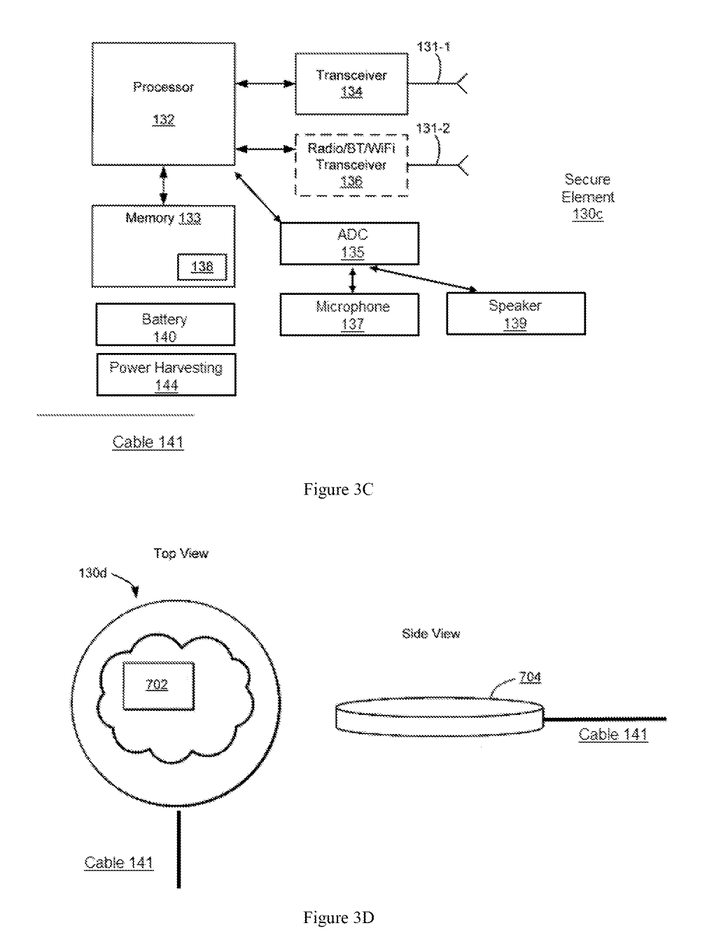

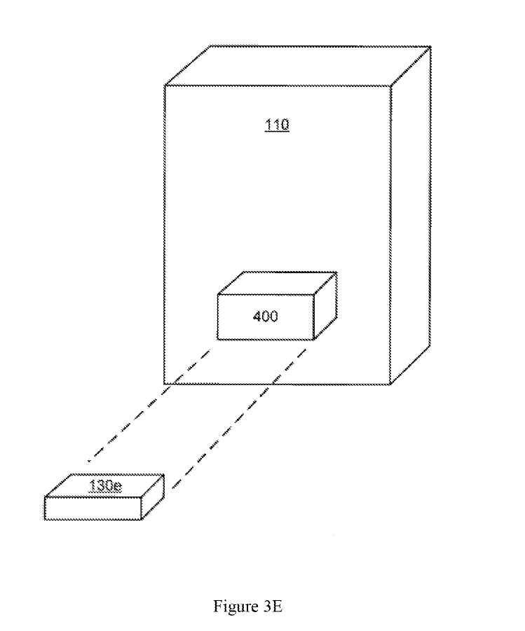

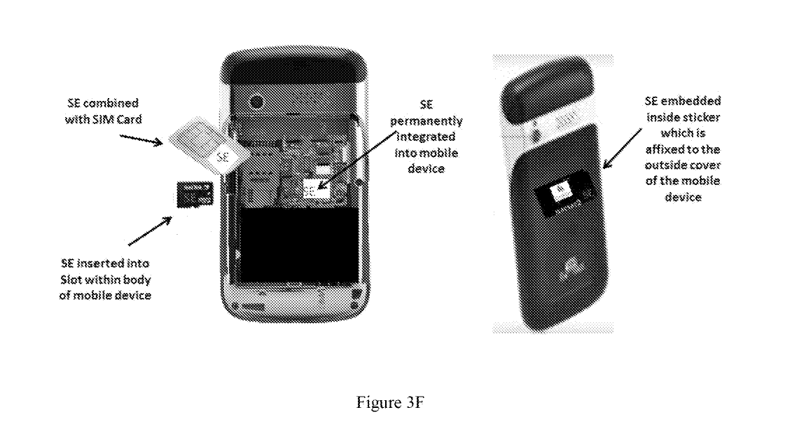

FIG. 3A is a block diagram illustrating a secure element 130a in accordance with some embodiments. The secure element 130a, which is an example of the secure element 130 (FIG. 1), includes a processor 132, a memory 133, and a wireless transceiver 134 with a corresponding antenna 131-1, a microphone 137, a speaker 139, and audio to digital converter 135, and audio cable 141 that has a 3.55 mm plug . The memory 133 includes a memory element 138 (e.g., a register, or alternatively a group of memory cells in a memory array in the memory 133) for storing an identifier (e.g., a serial number) associated with the secure element 130a. The memory element 138 is non-volatile and thus can store the identifier even in the absence of power. The transceiver 134 is adapted to communicate wirelessly with POS and POE terminals 150 (FIG. 1). For example, the transceiver 134 is adapted to send transaction request signals to POS terminals 150, to send entry request signals to POE terminals 150, and to receive corresponding responses from the terminals 150. In some embodiments, the transceiver 134 is a near-field communication (NFC) transceiver (e.g., operating in accordance with the ISO 18092 standard), which includes an NFC modem. In some implementations, the NFC modem has a set of registers that can be read and written by the processor 132 and are also available for reading and writing by an external device (e.g., a POS or POE terminal 150) over the wireless (e.g., RFID) communications channel between the transceiver 134 and the external device. This set of registers serves, for example, as a shared memory between the processor 132 within the secure element 130 and an RFID reader associated with a POS or POE terminal 150. This communication between the secure element 130a and POS or POE terminal 150 is performed, for example, in accordance with the ISO 14443A/B standard and/or the ISO 18092 standard.

In some embodiments, the secure element 130a includes one or more additional transceivers 136 (e.g., radio, Bluetooth, and/or WiFi transceivers) and associated antennas 131-2. The one or more additional transceivers 136 are adapted to communicate wirelessly with the mobile communication device 110 (e.g., via the transceiver 122 and/or 129 (FIG. 2) in the mobile communication device 110).

In some embodiments, the secure element 130a includes a second microphone (137), a second speaker (139) , a second analog to digital converter (136), and a second battery as shown in FIG. 3b. These components are adapted to communicate wirelessly with the mobile communication device 110 (e.g., via the microphone 118 and/or speaker 117 (FIG. 2) in the mobile communication device 110).

In some embodiments, the secure element 130, while physically coupled to the mobile communication device 110, is not electrically coupled to the device 110 and does not receive power from the device 110. Instead, for example, the secure element 130a receives RF power from a remote terminal (e.g., a POS or POE terminal 150) resulting from induction when in proximity to the remote terminal and uses this power to operate the processor 132, memory 133, and transceivers 134 and 136.

In some embodiments, the secure element 130 is electronically coupled to the mobile communication devices and receives its power directly from the battery 128 within the mobile communication device. This is accomplished when the mobile wallet application which resides on the mobile communication device sends a low voltage current using the cable 141 connected to the secure element in order to trigger induction and to activate the secure element

In some embodiments, the secure element 130 is electronically coupled to the mobile communication devices and receives its power indirectly from the battery 128 within the mobile communication device. This is accomplished when the mobile wallet application which resides on the mobile communication sends an audio signal and thereby creating an electronic current over the cable 141 connected to the secure element which triggers induction and activates the secure element 130

In some embodiments, the components of the secure element 130a are implemented on a single integrated circuit (IC); this single integrated circuit is sometimes referred to as a smart chip. The smart chip and any other components (e.g., the battery 140, FIG. 3B, or power harvesting circuitry 144, FIG. 3C) of the secure element 130 are encased within a card, referred to as a smart card, that serves as a housing of the secure element 130. In some embodiments, the smart card is adhesively affixed to the mobile communication device 110 and is referred to as a sticker.

FIG. 3D illustrates top and side views of a smart card 130d, which is an example of a secure element 130 (FIG. 1). The smart card 130d can be attached (e.g., affixed) externally to a mobile communication device 110. In FIG. 3D, the smart card 130d has a circular shape. The smart card 130d can have other suitable shapes (e.g., rectangular, triangular, and so on). The smart card 130d includes an embedded smart chip 702 that includes the components of the secure element 130a (FIG. 3A). The smart chip 702 is capable of 2-way wireless communication with a remote terminal (e.g., a POS or POE terminal 150) and with the mobile communication device 110 using the transceivers 134 or 136.

In some embodiments, the transceivers 134 and/or 136 in the smart chip 702 are low-power RF transceivers. Their low power output makes them susceptible to RF interference from neighboring devices, such as the mobile communication device 110 to which the smart card 130d is attached. Thus, in some implementations, the smart card 130d includes an RF shield to insulate the smart chip 702 from external interference. In one implementation, a lining of the smart chip 702 is composed of an RF absorbent material. In general, each phone has different levels of interference, and a material, size and thickness of the RF lining can determine an effectiveness of the RF shield. Alternatively, instead of incorporating an RF shield within the smart card 130d, an RF shield can be placed between the smart card 130d and the mobile communication device 110.

Given the abuse a mobile communication device 110 can take, smart cards 130d that are attached externally to a mobile communication device are designed to withstand some abuse. In some embodiments, the smart card 130d includes a ruggedized shell 704 that encases the smart chip 702. In some implementations, the shell 704 is formed of a composite plastic or polymer. The shell 70 can be hard (and substantially inflexible) or soft (and pliable). In some implementations, the shell 704 includes a protective membrane for the smart chip 702 which prevents damage to internal circuitry of the smart chip 702, a surface to adhere to an RF lining and/or the mobile communication device 110 with appropriate adhesive, and a surface that faces outward when the smart card 130d is attached to the mobile communication device 110, on which to print branding and advertising. Types of adhesives that can be used to affix the smart card 130d to the mobile communication device 110 include, for example, paper glue, super glue, adhesive polymers, and the like. In one implementation, the shell 704 has a maximum width (or diameter) of 25 mm, and has a maximum thickness (or depth) of 5 mm.

In some embodiments, instead of being externally attached to the mobile communication device 110, a secure element 130 is physically coupled to the mobile communication device 110 by being disposed internally within a body of the mobile communication device 110. For example, as shown in FIG. 3E in accordance with some embodiments, the mobile communication device 110 includes a slot 400 into which a secure element 130e is inserted. The secure element 130e is an example of a secure element 130a, 130b, or 130c (FIGS. 3A-3C). Even though the secure element 130e is physically housed within the slot 400, the secure element 130e and the mobile communication device 110 still communicate wirelessly with each other. Accordingly, in some implementations the slot 400 only provides for physical insertion and mechanical connection of the secure element 130e to the body of the mobile communication device 110, and does not electrically couple the secure element 130e to the mobile communication device 110. FIG. 3F shows these various embodiments of a secure element coupled to a mobile communication device.

FIG. 3 illustrates one implementation of the mobile communication device 102. The mobile communication device 102 includes a mobile application 200 that (in one implementation) is provided to the mobile communication device 102 through a remote server (e.g., management server 106). In one implementation, the mobile application is a Mobile Wallet application available from Blaze Mobile, of Berkeley, Calif. In one implementation, the mobile application is a hosted service, as described in U.S. patent application Ser. No. 11/956,261, titled “Method and System for Delivering Customized Information To A Mobile Communication Device Based on User Affiliations” filed Dec. 13, 2007, which is incorporated herein by reference. In one implementation, the mobile application 200 is configured to send requests to the management server for artifacts based on user input, e.g., received though a keypad (not shown) of the mobile communication device 102. Requests to the management server 106 can also be automated, via proximity-based services, e.g., consumer tapping (or in close proximity) an LBS/contactless/RFID enabled phone against a smart poster (RFID/Bluetooth/LBS enabled, etc.), kiosk, or other device.

As shown in FIG. 5, the mobile application 200 includes a user interface 202 that is displayable on a display of the mobile communication device 102. In one implementation, the user interface 202 is a generic user interface (or platform) that can be customized based on one or more special interest groups (SIG) that are affiliated with a user of the mobile communication device 102. In general, the user interface 202 can be customized to display, e.g., screens, logos, messages, maps, coupons, advertisements, and other information, as discussed in greater detail below. In one implementation, a special interest group (SIG) is an organization. For example, a special interest group can be a social media group (i.e. Fans on Facebook page, followers on Twitter, followers on Youtube, friends on Linkedin, etc), university, corporation, military, government, sports team, alumni association, and the like. These (and other SIGs) generally have a need to brand and customize mobile applications they either sponsor or associate their name to. Co-branding the mobile application with well-known third party brands will facilitate community exposure, help drive consumer acceptance and adoption through viral marketing (inherent to the community) as well as marketing programs by the SIG.

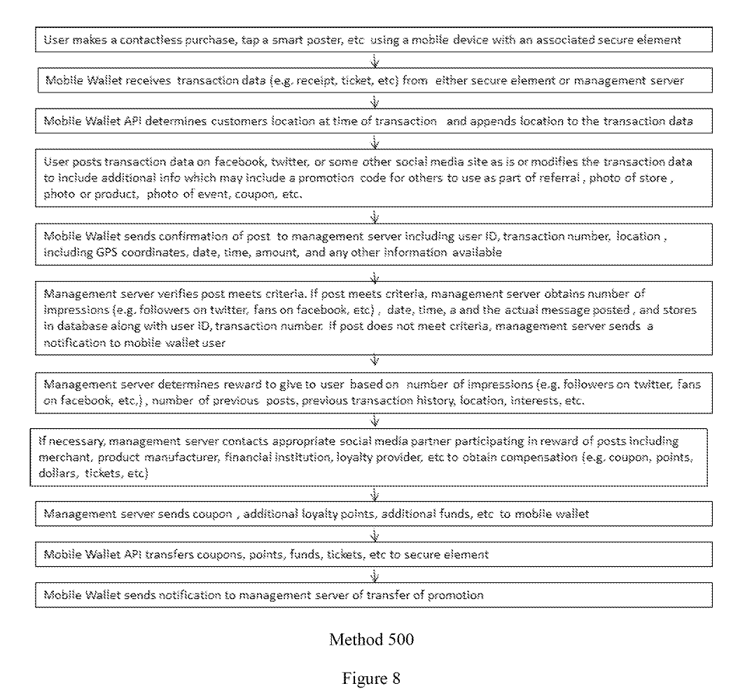

Attention is now directed to methods of communication between various elements of the method 500 in FIG. 8. After a purchase is made with a mobile communication device with a secure element that enables contactless payment via induction resulting from holding the mobile communication device in proximity to a POS with NFC, the transaction information is transmitted using induction directly to the secure element and subsequently transferred to the mobile wallet for display. Alternatively, the transaction information is transferred to the management server using WIFI or the carrier network and the management server subsequently transfers it to the mobile wallet using the carrier network, WIFI etc. In either case and for all of the embodiments described in this specification, the user may have to enter a userlD and password to access their mobile wallet and view the transaction. The “Mobile Wallet PIN” which this is referred to is authenticated remotely by the management server using a carrier network. If the user logins to the mobile wallet using their social media ID and password, the user is first authenticated by the management server which then transmits the login credentials to the social media server for authentication. So, the user is logged into both the mobile wallet and the social media site automatically which is sometimes referred to as “single sign on”.

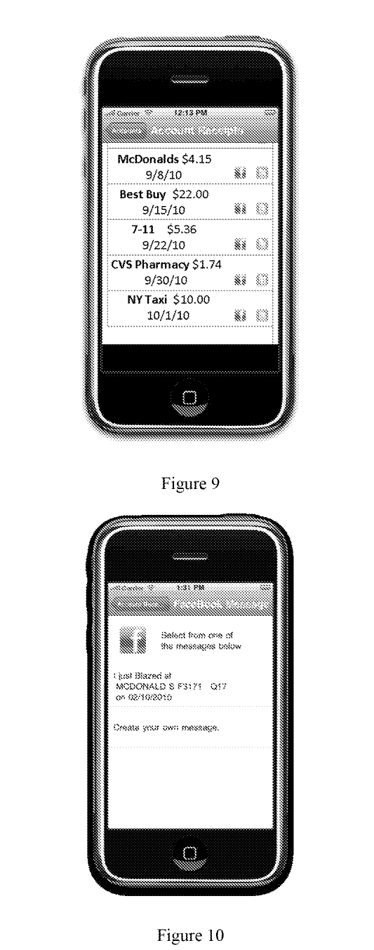

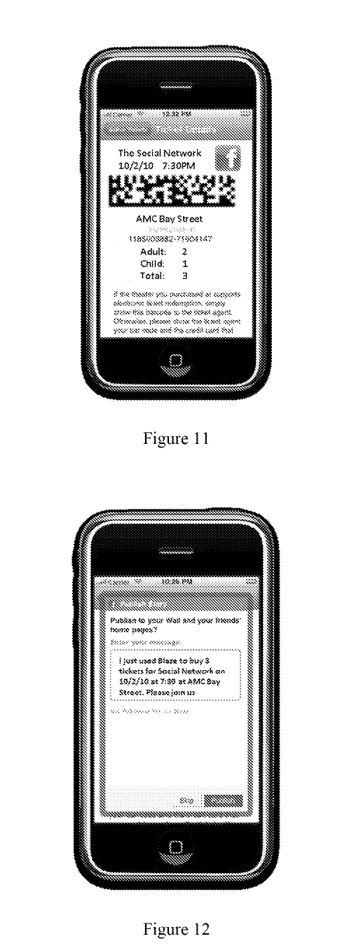

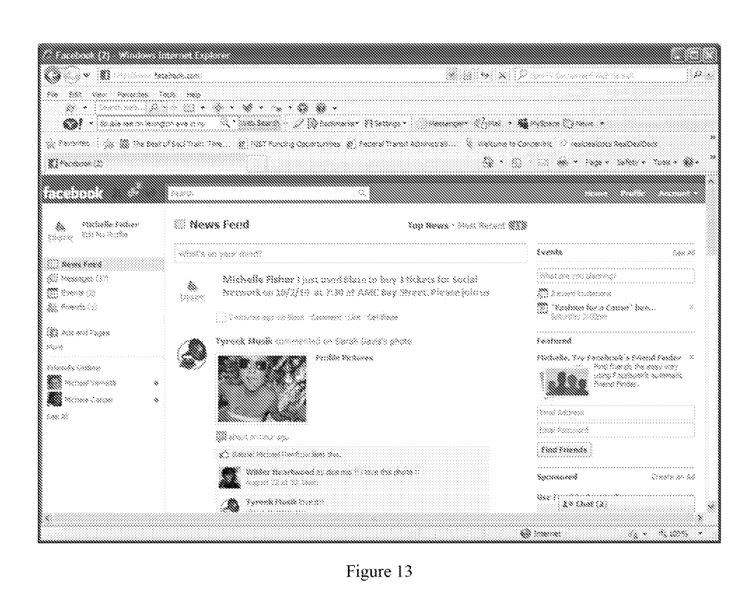

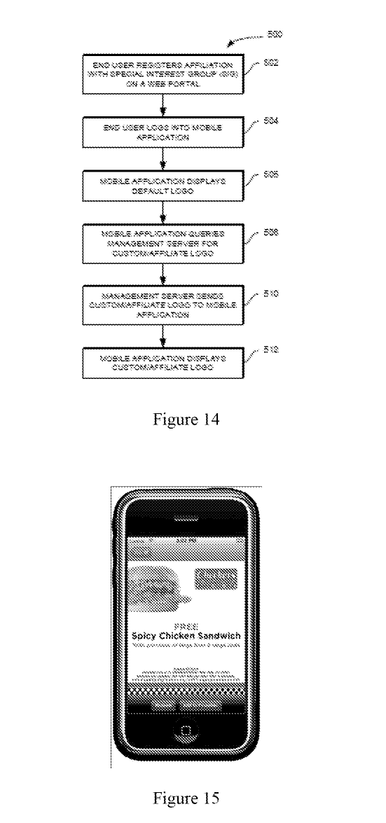

A user opens their mobile wallet and enters their userid and password if necessary which is authenticated by the remote management server. If the user logins to the mobile wallet using their social media ID and password, the user is first authenticated by the management server which then transmits the login credentials to the social media server for authentication. So, the user is logged into both the mobile wallet and the social media site automatically which is sometimes referred to as “single sign on”. After logging in, the user can select or click on the icon next to the transaction with such icon representing Facebook twitter, or any other social media site (FIG. 9) . After selecting the icon, the mobile wallet will automatically generate and display a customizable message to the user which includes information about the transaction such as the merchant name, merchant location, product ID, product name, cost, date of purchase, date of event, seat location, venue name, venue address, Etc (FIG. 10). For event ticket purchases such as movies, the mobile wallet will generate and display a message to the user that includes the transaction details associated with the event such as event name, venue name, venue location, date time , seat location, etc (FIG. 12). A user can edit the message or post it” as is” which includes information about the transaction such as the merchant name, merchant location, product ID, product name, cost, date of purchase, date of event, seat location, venue name, venue address on their Facebook page , twitter page, or any other social media page (FIG. 13). Alternatively, the user can modify the canned or preformatted message and add additional text, change the canned text, delete the canned text, add a picture, etc. For an online purchase (not shown) using a mobile wallet with a secure element, the mobile wallet will generate a message of the transaction that includes the product name, merchant name, date , time , cost, etc. Prior to the post, the mobile wallet may prompt the user to enter their id and password for the social media site if authorization is required and “single sign in” is not available meaning that the mobile wallet user id and password used to access the mobile wallet is not the same as the social media userid and password. If the mobile wallet prompts the user for their social media user id and password, the mobile wallet transmits this to the social media site for authentication using the wireless carrier network, WIFI, etc . Upon successful authentication, the user is able to post the message on the social media site

In other embodiments, a user may load any credit card, debit card, checking account, savings account into their mobile wallet which enables the mobile wallet to retrieve transactions associated with these accounts from either the management server where they might be stored or the appropriate financial institution. Stated another way, the mobile wallet will display all transactions associated regardless of the payment method including NFC mobile device, SMS, WAP browser, traditional in store purchase using a magnetic stripe card, in store purchase with a contactless card, online purchase tec. If the management stores or is able to retrieve from financial institution any transaction data associated with any of these payment methods, the management server can deliver it to the mobile wallet where it can be displayed to the user. The user can also select the social media icon available for each of these transactions as well. A user opens their mobile wallet and enters their userid and password if necessary which is authenticated by the remote management server. If the user logins to the mobile wallet using their social media ID and password, the user is first authenticated by the management server which then transmits the login credentials to the social media server for authentication. So, the user is logged into both the mobile wallet and the social media site automatically which is sometimes referred to as “single sign on”. After opening their wallet and selecting the icon next to the transaction, the mobile wallet will automatically generate and display a customizable message to the user which includes information about the transaction such as the merchant, product ID, product name, cost, date of purchase. Etc (FIG. 10). A user can edit the message or post it” as is” on their Facebook page, twitter page, or any other social media page. Alternatively, the user can modify the canned or preformatted message and add additional text, change the canned text, delete the canned text, add a picture, etc. So, for example, the transaction data or receipt may include “2 tickets purchased for The Movie at the AMC on Friday night at 9 PM”, but the user may modify the canned message and add the following text “Join us for before for dinner at the Italian Restaurant on 8th”, so the message posted is “2 tickets purchased for The Movie at the AMC on Friday night at 9 PM”. Join us for dinner at the Italian Restaurant on 8^{th}”. In another example, a user may purchase tickets to a ball game, take a picture while at the game and modify the canned post of 2 tickets to the ball game on Sunday at 2 PM” by adding the picture and a message such as “2 tickets to the ball game on Sunday at 2 PM . Here's a picture of the homerun”. Prior to the post, the mobile wallet may prompt the user to enter their id and password for the social media site if authorization is required and “single sign in” is not available meaning that the mobile wallet user id and password used to access the mobile wallet is not the same as the social media userid and password. If the mobile wallet prompts the user for their social media user id and password, the mobile wallet transmits this to the social media site for authentication using the wireless carrier network, WIFI, etc . Upon successful authentication, the user is able to post the message on the social media site

As shown in FIG. 8, a user first makes a purchase by holding their mobile communication device with an associated secure element near an NFC Point of Sale device. In doing so, the POS device triggers the payment application stored in the secure element and the payment credentials are transferred from the secure element to the POS device. The user can also hold their mobile device with associated secure element near a smart poster that has an NFC or RFID chip affixed to it to make a purchase, receive a coupon, etc. As mentioned previously, a user can also purchase an item with SMS, WAP, magnetic stripe card, online purchase, etc. In this case, the management server retrieves the transactions from the financial institution, stores the transactions, and delivers them to the mobile wallet for display. After the transaction, the POS device transfers the transaction data (e.g. receipt, ticket, coupon, etc.) to the secure element. using one of several methods described by patents referenced including U.S. Patent Application No. 61/445,667, entitled “Non-Wireless Bidirectional Communications between a Mobile Device and Associated Secure Element using An Audio Port,” filed Feb. 23, 2011, U.S. Patent Application No. 61/431,077, entitled “Non-Wireless Bidirectional Communications between a Mobile Device and Associated Secure Element,” filed Feb. 10, 2011 ,U.S. Patent Application No. 61/429,246 entitled “Wireless Bidirectional Communications between a Mobile Device and Associated Secure Element using Inaudible Sound Waves,” filed Jan. 3, 2011 , U.S. patent application Ser. No. 12/948,717, entitled “Wireless Bidirectional Communications between a Mobile Device and Associated Secure Element,” filed Nov. 17, 2010, U.S. patent application Ser. No. 11/933,321, en titled “Method and System for Adapting a Wireless Mobile Communication Device for Wireless Transactions,” filed Oct. 31, 2007, and U.S. patent application Ser. No. 12/592,581, entitled “Method and Apparatus for Completing a Transaction Using a Wireless Mobile Communication Channel and Another Communication Channel,” filed Nov. 25, 2009. Alternatively, the POS device transfers the transaction data to the transaction server 170 in FIG. 1 which then transfers it to the management server 180. The management server transfers the transaction data to the mobile wallet and displays the transaction data to the user. This process has been described in patent filings which have been previously referred to in this specification.

The Mobile Wallet API determines the user's location at time of transaction and appends location to the transaction data. The user's location can be determined in a number of ways. The Mobile wallet can determine it by GPS, triangulation, or the actual location of retail merchant the user made a purchase at. In the latter case, if a user uses an NFC phone to make the purchase the POS terminal will generate a digital receipt and transmit it to the secure element directly which can subsequently be transferred to the mobile wallet. The mobile wallet can parse the digital receipt and obtain the store ID and or physical location. If the receipt simply has the store ID, the mobile wallet can transfer this to the management server which can look up the store ID and correlate it to the physical street address. Alternatively, if the POS does not transmit the receipt to the secure element, the POS can transmit it to the management server which can subsequently identify the physical store location and transmit it to the mobile wallet using the carrier network, WIFI, etc.

In another embodiment, a user's location can be determined by their social media login ID (e.g. twitter username, Facebook username, etc), last tweet or photo posted since tweets, Facebook posts, and digital photos in particulars have location have location information (e.g. latitude, longitude coordinates) and time for that location embedded in them. Social Media ID's may also have locations associated with users . The management server can also employ predictive algorithms to forecast a user's location based on historical data of past locations and times.

After opening the mobile wallet (and entering the “mobile wallet” user id and password if necessary), the user views the transaction in the wallet and posts the transaction data by pressing their finger on the social media icon for a phone that has a touch screen or clicks on the icon next to the transaction using the appropriate buttons (FIG. 9). Upon selecting the transaction, the wallet SPI creates a custom message which includes the transaction data (FIG. 10) and can optionally combined with the location and any other data and displays this to the user. The user can post the transaction data “as is” or modify the transaction data to include additional info which may include a promotion code for others to use as part of referral, photo of store , photo or product, photo of event, coupon, etc. Prior to the post, the mobile wallet may prompt the user to enter their userid and password for the social media site if authorization is required and “single sign in” is not available meaning that the mobile wallet user id and password used to access the mobile wallet is not the same as the social media userid and password. If the mobile wallet prompts the user for their social media user id and password, the mobile wallet transmits this to the social media server for authentication using the wireless carrier network, WIFI, etc . Upon successful authentication, the user is able to post the message on the social media site.

The Mobile Wallet sends a confirmation of the post to management server including user ID/Wallet ID which may be the users 10 digit cell phone number, transaction number, location , including GPS coordinates, date, time, amount, and any other information available. The management server verifies post meets criteria by comparing the information sent with a set of criteria stored in the databases associated with the management server (FIG. 7) . If post does not meet the criteria, management server sends a notification to mobile wallet user using standard wireless communication as WIFI, wireless carrier, etc. Once the mobile device receives the notification, it displays it to the user in their mobile wallet.

If the post meets pre-defined criteria by the management server and optionally the SIG, the management server obtains number of users who saw the post which may also be referred to as “impressions” (e.g. followers on twitter, fans on Facebook, followers on Youtube friends on Linkedin, etc) using XML, “HTTP GET”, or an API provided by the social media site, or any standard internet program. The management server also retrieves the date, time, and the actual message posted , and stores this information in the database along with user ID, transaction number. In another embodiment, a user's CPM can be determined from 3^{rd} party social media rating system such as Klout which not only captures the number of followers on various social media sites, but provides a quantities value on the persons influence in reach other people, quantitative value on whether posts will be acted upon, etc. In other words, the management server may utilize a user's direct impressions; one or more quantitate values from 3^{rd} party rating services, or a combination of these. Stated another way, every user is an advertiser and their “CPM” number or the number of impressions they can make are not static or limited to just their followers. A users CPM can increase over time as they obtain more followers, neutral 3^{rd} party rating systems provide quantitate values that increase their clout or “impressions, and their ability to impact others to take action on their posts increase. The management server can take an average of all of these numbers, the maximum of these numbers, the weighted average of these numbers to arrive at a calibrated CPM. In other words, even though a user may have a large number of followers, their ability to affect other users to act on a post is low. In the opposite scenario, a user may have a low number of followers, but their ability to influence other users to act on a post is high. So, the management server, may provide a higher compensation the user based on their ability to influence other users to act on a post.

FIG. 7 illustrates one implementation of a communication system 400. The communication system 400 includes a hand-held, wireless mobile communication device 402, a management server 404, a user portal 406, and a special interest group (SIG) portal 408. In one implementation, the management server 180 is coupled to a user and profile database 410, an affiliate content database 412, and an integrated marketing database 414. In one implementation, the user and profile database 410 stores user profile information associated with each user—e.g., passwords, personal identification numbers (PINs), contact information, e-mail addresses, and the like; the affiliate content database 412 stores associations between special interest groups (SIGs) and users; the integrated marketing database 414 stores artifacts (e.g., coupons, advertising, tickets, etc.) that can be sent to a user; the social media web pages include Twitter, Facebook, MySpace, etc.; The social media partners include partners that participate in providing compensation to users for their posts such as merchants, product manufacturers, reward card programs, coupon vendors such as Groupon, etc.

The management server uses all of the transaction information, location information as well as information from the user and profile database 410 in FIG. 7, integrated marketing database 414 in FIG. 7, and the affiliate content database 412 in FIG. 7. to determine the reward to give to user based on number of impressions (e.g. followers on twitter, fans on Facebook, etc.), number of previous posts by the user, significance of previous posts as measured by new posts generated or ratings by 3^{rd} party systems such as Klout, location of purchase, merchant item was purchased by, transaction amount, payment method (e.g. using NFC, SMS, WAP, traditional card), previous transaction history, number of new posts generated by the post (e.g. “Retweets”), etc. If necessary, management server contacts appropriate participating partners 430 (e.g. merchant, product manufacturer, financial institution, loyalty provider, etc) to determine and provide compensation to the user in the form of a digital artifact which includes but not limited to debit/prepaid/credit card, receipts, tickets, advertisements, coupons, loyalty points, gift cards, vouchers, content (video, image, ringtone, movie), games, documentation, etc.

The management server transmits compensation (e.g. coupons , additional loyalty points, additional funds, etc) to the mobile wallet using wireless carrier, WIFI, etc over the second communications channel defined in patent filings referenced herein. The mobile wallet API transfers coupons, points, funds, tickets, etc. to the secure element using the wireless or non-wireless methods described previously in section. If the secure element is locked, the management server may have to unlock it per the methods described in U.S. patent application Ser. No. 13/184,209 entitled “Method and Systems of loading and unloading digital artifacts between a mobile device with an associated secure element and other remote devices” filed Jul. 15, 2011”. Mobile Wallet sends notification to management server of transfer of promotion

In another embodiment, the user may include a referral number or promotion code in their transaction related post (i.e. a post based on transactions from using the secure element associated with their mobile device for payments or any other transaction associated with the financial accounts registered in their mobile wallet) to their Special Interest Group (e.g. fans on Facebook, followers on twitter , or any members affiliated with a social media group). If any one of the members of the SIG utilizes this code during an in-store purchase with their mobile wallet and associated secure element, online purchase using their mobile wallet, smart poster or some other transaction using their mobile wallet and associated secure element, their transaction is automatically registered by the management server with the referral code, date, time, amount of transaction, etc. The management server will determine if the user who placed the original transaction related post with the promotion code will receive some compensation such as points, coupons, money, ticket, etc. If the compensation is a coupon, ticket, or additional money, the mobile wallet will transfer the compensation digitally to the secure element or to the mobile wallet using methods described in previous patent filings referenced previously. If the secure element is locked, the management server may have to unlock it per the methods described in U.S. patent application Ser. No. 13/184,209 entitled “Method and Systems of loading and unloading digital artifacts between a mobile device with an associated secure element and other remote devices” filed Jul. 15, 2011.

Members of the SIG who refer to the promo code during their transaction using their mobile communication device with an associated secure element will also receive additional compensation for the purchase as well as any social media posts that the conduct. This is accomplished when the user enters the promo code in their mobile wallet and the mobile wallet transfers the promo code to the secure element. The promo code is then utilized like a coupon such that when the user holds their mobile communication device near the NFC POS, the POS device applies a discount or the appropriate compensation related to the promotion to the purchase. If the user posts the transaction based on using the referral code on a social media site, the management server will determine additional compensation to the user (in the form of a digital artifact which includes but not limited to debit/prepaid/credit card, receipts, tickets, advertisements, coupons, loyalty points, gift cards, vouchers, content (video, image, ringtone, movie), games, documentation, etc.) and transfer compensation to their mobile wallet which will transfer it to the secure element or the mobile wallet using methods reference previously in this specification. Prior to the post, the mobile wallet may prompt the user to enter their id and password for the social media site if authorization is required and “single sign in” is not available meaning that the mobile wallet user id and password used to access the mobile wallet is not the same as the social media userid and password. If the mobile wallet prompts the user for their social media user id and password, the mobile wallet transmits this to the social media site for authentication using the wireless carrier network, WWI, etc . Upon successful authentication, the user is able to post the message on the social media site. If the secure element is locked, the management server may have to unlock it per the methods described in U.S. patent application Ser. No. 13/184,209 entitled “Method and Systems of loading and unloading digital artifacts between a mobile device with an associated secure element and other remote devices” filed Jul. 15, 2011.

In another embodiment, the user can post a transaction directly on television or on a social media site where it is subsequently posted on television. A user opens their mobile wallet and enters their userid and password if necessary which is authenticated by the remote management server. If the user logins to the mobile wallet using their social media ID and password, the user is first authenticated by the management server which then transmits the login credentials to the social media server for authentication. So, the user is logged into both the mobile wallet and the social media site automatically which is sometimes referred to as “single sign on”. After opening the mobile wallet if the mobile wallet user places a transaction related post (i.e. a post based on transactions from using the secure element associated with their mobile device for payments or any other transaction associated with the financial accounts registered in their mobile wallet) on a social media site “as is” or a modified version and the transaction related post is broadcast on television, the mobile wallet user must notify the management server about the post, time, date, and TV program as well as provide proof of the post. The user can notify the management server via the user web portal 406 in FIG. 7. Alternatively, the user can use an API in the mobile wallet to submit this information to the management server. The management server will determine the number of impressions (i.e. number of viewers) and number of new posts generated by that post (e.g. “Retweets”) at that time and provide any necessary compensation. Alternatively, the TV program may transfer the post electronically to the management server using the wireless carrier network, WIFI, etc. If the compensation is a coupon, ticket, or additional funds, the mobile wallet will transfer them to the secure element or mobile wallet using methods described in previous patent filings referenced previously in this specification. Prior to the post, the mobile wallet may prompt the user to enter their id and password for the social media site if authorization is required and “single sign in” is not available meaning that the mobile wallet user id and password used to access the mobile wallet is not the same as the social media userid and password. If the mobile wallet prompts the user for their social media user id and password, the mobile wallet transmits this to the social media site for authentication using the wireless carrier network, WWI, etc . Upon successful authentication, the user is able to post the message on the social media site. If the secure element is locked, the management server may have to unlock it per the methods described in U.S. patent application Ser. No. 13/184,209 entitled “Method and Systems of loading and unloading digital artifacts between a mobile device with an associated secure element and other remote devices” filed Jul. 15, 2011.

In another embodiment, a user may post a transaction on a social media site and it is subsequently printed in a magazine, newspaper, or other printed medium. A user opens their mobile wallet and enters their userid and password if necessary which is authenticated by the remote management server. If the user logins to the mobile wallet using their social media ID and password, the user is first authenticated by the management server which then transmits the login credentials to the social media server for authentication. So, the user is logged into both the mobile wallet and the social media site automatically which is sometimes referred to as “single sign on”.). If the mobile wallet user places a transaction related (i.e. a post based on transactions from using the secure element associated with their mobile device for payments or any other transaction associated with the financial accounts registered in their mobile wallet) on a social media site and the post is printed in a magazine, newspaper, or some other printed medium, the mobile wallet user must notify the management server about the post, time, date, and publication as well as provide proof of the post using either the user portal 406 or an API in the mobile wallet. The management server will determine the number of impressions (i.e. number of readers) of the printed media at that time , number of new posts generated from the post (e.g. “Retweets”) and provide any necessary compensation either via traditional means such as mailing a check or electronically to the mobile wallet or the secure element. Alternatively, the printed publication may transfer the post electronically to the management server which transfers it to the mobile wallet. If the compensation is a digital artifact which includes but not limited to debit/prepaid/credit card, receipts, tickets, advertisements, coupons, loyalty points, gift cards, vouchers, content (video, image, ringtone, movie), games, documentation, etc.), the mobile wallet will transfer them to the secure element using methods described in previous patent filings referenced previously. Prior to the post, the mobile wallet may prompt the user to enter their id and password for the social media site if authorization is required and “single sign in” is not available meaning that the mobile wallet user id and password used to access the mobile wallet is not the same as the social media userid and password. If the mobile wallet prompts the user for their social media user id and password, the mobile wallet transmits this to the social media site for authentication using the wireless carrier network, WIFI, etc . Upon successful authentication, the user is able to post the message on the social media site. If the secure element is locked, the management server may have to unlock it per the methods described in U.S. patent application Ser. No. 13,184,209 entitled “Method and Systems of loading and unloading digital artifacts between a mobile device with an associated secure element and other remote devices” filed Jul. 15, 2011.

In another embodiment, a user's post on a social media site is printed on a bill board or poster . A user opens their mobile wallet and enters their userid and password if necessary which is authenticated by the remote management server. If the user logins to the mobile wallet using their social media ID and password, the user is first authenticated by the management server which then transmits the login credentials to the social media server for authentication. So, the user is logged into both the mobile wallet and the social media site automatically which is sometimes referred to as “single sign on”. If the user places a transaction related post (i.e. a post based on transactions from using the secure element associated with their mobile device for payments or any other transaction associated with the financial accounts registered in their mobile wallet) “as is” or a modified version on a social media site and the post is incorporated into a bill board or poster located on a bus, train, building, etc. the user must notify the management server provider about the post, time, date, and location well as provide proof of the post. The management server will determine the number of impressions (i.e. readers of bill board or poster) at that time and provide any necessary compensation via traditional means such as mailing a check or electronically to the mobile wallet or the secure element. Alternatively, the transit agency may transfer the post electronically to the management server which transmits the compensation to the mobile wallet using the wireless carrier network, WIFI, etc. If the compensation is a coupon, ticket, or additional funds, the mobile wallet will transfer them to the secure element using methods described in previous patent filings referenced previously in this specification. Prior to the post, the mobile wallet may prompt the user to enter their id and password for the social media site if authorization is required and “single sign in” is not available meaning that the mobile wallet user id and password used to access the mobile wallet is not the same as the social media userid and password. If the mobile wallet prompts the user for their social media user id and password, the mobile wallet transmits this to the social media site for authentication using the wireless carrier network, WIFI, etc . Upon successful authentication, the user is able to post the message on the social media site. If the secure element is locked, the management server may have to unlock it per the methods described in U.S. Patent Application No. 61/442,384, titled U.S. patent application Ser. No. 13/184,209 entitled Method and Systems of loading and unloading digital artifacts between a mobile device with an associated secure element and other remote devices” filed Jul. 15, 2011.

In another embodiment, a user's post to a social media site may be printed or displayed on a smart poster which is a poster that is equipped with an RFID or NFC tag that is encoded with information that can be “read” by an NFC enabled device. A user opens their mobile wallet and enters their userid and password if necessary which is authenticated by the remote management server. If the user logins to the mobile wallet using their social media ID and password, the user is first authenticated by the management server which then transmits the login credentials to the social media server for authentication. So, the user is logged into both the mobile wallet and the social media site automatically which is sometimes referred to as “single sign on”.). If the user places a transaction related post (i.e. a post based on transactions from using the secure element associated with their mobile device for payments or any other transaction associated with the financial accounts registered in their mobile wallet) “as is” or a modified version on a social media site and the post is incorporated into a smart poster (a poster that has an RFID tag affixed to it, encoded with information such as a coupon, URL, ticket, etc and that can be read by any RFID reader including a mobile device that has an NFC chip, smart sticker, NFC on SD, or NFC on SIM, etc), the user must notify the management server about the post, time, date, and location well as provide proof of the post. The management server will determine the number of impressions and will also track the number of times that the RFID tag associated with the smart poster was “read” and then number of new postings (e.g. “Retweets”) that were generated by other users who used their mobile wallet to read the tag and to place a post their social media page. The management server will transmit the compensation (in the form of a digital artifact which includes but not limited to debit/prepaid/credit card, receipts, tickets, advertisements, coupons, loyalty points, gift cards, vouchers, content (video, image, ringtone, movie), games, documentation, etc.) directly to the secure element or to the mobile wallet using the wireless carrier network or WWI. Alternatively, the owner of the smart poster may transfer the post electronically to the management server. The management server will determine the compensation. If the compensation is a coupon, ticket, or additional finds, the mobile wallet will transfer them to the secure element using methods described in previous patent filings referenced previously in this specification. Prior to the post, the mobile wallet may prompt the user to enter their id and password for the social media site if authorization is required and “single sign in” is not available meaning that the mobile wallet user id and password used to access the mobile wallet is not the same as the social media userid and password. If the mobile wallet prompts the user for their social media user id and password, the mobile wallet transmits this to the social media site for authentication using the wireless carrier network, WIFI, etc. Upon successful authentication, the user is able to post the message on the social media site. If the secure element is locked, the management server may have to unlock it per the methods described in U.S. patent application Ser. No. 13/184,209 entitled “Method and Systems of loading and unloading digital artifacts between a mobile device with an associated secure element and other remote devices” filed Jul. 15, 2011.

In a preferred embodiment, a user's post to a social media site may be displayed on a website. A user opens their mobile wallet and enters their userid and password if necessary which is authenticated by the remote management server. If the user logins to the mobile wallet using their social media ID and password, the user is first authenticated by the management server which then transmits the login credentials to the social media server for authentication. So, the user is logged into both the mobile wallet and the social media site automatically which is sometimes referred to as “single sign on”.). If the user places a transaction related post (i.e. a post based on transactions from using the secure element associated with their mobile device for payments or any other transaction associated with the financial accounts registered in their mobile wallet) “as is” or a modified version on a social media site and the post is displayed on a website, the user must notify the management server about the post, time, date, and location well as provide proof of the post. The management server will determine the number of impressions and will measure the website traffic including but not limited to the number of impressions or hits on the website, the number of times that the post was “read” and then number of new postings or “retweets” that were generated by the post. The management server will transmit the compensation (in the form of a digital artifact which includes but not limited to debit/prepaid/credit card, receipts, tickets, advertisements, coupons, loyalty points, gift cards, vouchers, content (video, image, ringtone, movie), games, documentation, etc.) directly to the secure element or to the mobile wallet using the wireless carrier network or WIFI. Alternatively, the owner of the web site may transfer the post electronically to the management server. The management server will determine the compensation. If the compensation is a coupon, ticket, or additional funds, the mobile wallet will transfer them to the secure element using methods described in previous patent filings referenced previously in this specification. Prior to the post, the mobile wallet may prompt the user to enter their id and password for the social media site if authorization is required and “single sign in” is not available meaning that the mobile wallet user id and password used to access the mobile wallet is not the same as the social media userid and password. If the mobile wallet prompts the user for their social media user id and password, the mobile wallet transmits this to the social media site for authentication using the wireless carrier network, WIFI, etc. Upon successful authentication, the user is able to post the message on the social media site. If the secure element is locked, the management server may have to unlock it per the methods described in U.S. patent application Ser. No. 13/184,209 entitled “Method and Systems of loading and unloading digital artifacts between a mobile device with an associated secure element and other remote devices” filed Jul. 15, 2011.

In a final embodiment, a user's post to a social media site may be printed on an article of clothing such as a t-shirt, baseball cap, jacket, headband, sweater, pants, etc. A user opens their mobile wallet and enters their userid and password if necessary which is authenticated by the remote management server. If the user logins to the mobile wallet using their social media ID and password, the user is first authenticated by the management server which then transmits the login credentials to the social media server for authentication. So, the user is logged into both the mobile wallet and the social media site automatically which is sometimes referred to as “single sign on”.). If the user places a transaction related post (i.e. a post based on transactions from using the secure element associated with their mobile device for payments or any other transaction associated with the financial accounts registered in their mobile wallet) “as is” or a modified version on a social media site and the post is printed on an article of clothing, the user must notify the management server about the post, time, date, and location well as provide proof of the post. The management server will determine the number of impressions the post hasand then number of new postings or “retweets” that were generated by the post. The management server will transmit the compensation (in the form of a digital artifact which includes but not limited to debit/prepaid/credit card, receipts, tickets, advertisements, coupons, loyalty points, gift cards, vouchers, content (video, image, ringtone, movie), games, documentation, etc.) directly to the secure element or to the mobile wallet using the wireless carrier network or WIFI. Alternatively, the owner of the clothing may transfer evidence of the post electronically to the management server. The management server will determine the compensation. If the compensation is a coupon, ticket, or additional funds, the mobile wallet will transfer them to the secure element using methods described in previous patent filings referenced previously in this specification. Prior to the post, the mobile wallet may prompt the user to enter their id and password for the social media site if authorization is required and “single sign in” is not available meaning that the mobile wallet user id and password used to access the mobile wallet is not the same as the social media userid and password. If the mobile wallet prompts the user for their social media user id and password, the mobile wallet transmits this to the social media site for authentication using the wireless carrier network, WIFI, etc . Upon successful authentication, the user is able to post the message on the social media site. If the secure element is locked, the management server may have to unlock it per the methods described in U.S. patent application Ser. No. 13/184,209 entitled “Method and Systems of loading and unloading digital artifacts between a mobile device with an associated secure element and other remote devices” filed Jul. 15, 2011.

To reiterate, a user may post a transaction to a social media site as long as the transaction is displayed in their mobile wallet regardless of whether the purchase was conducted using an NFC enabled device, SMS, WAP, traditional magnetic striped card, online, etc. When a mobile wallet user logins into their wallet, the management server will determine if they are members of a SIG (e.g. fans on Facebook page, followers on Twitter, etc). If a user logins to their mobile wallet using their twitter userlD, Facebook userid, or any other social media or SIG userlD, the user credentials (ie. User ID and password) are securely passed from the mobile wallet to the management server which authenticates the user at the SIG's portal. In doing so, the user is not only given access to the mobile wallet, but they are also automatically logged into their SIG. This is sometimes referred to as “single sign on”. In this scenario, once a user is logged into their mobile wallet using their social media ID/password, they can select to post a message to a social media site and not have to provide their id/password again to confirm the post. Stated another way, if the user does not login to the mobile wallet using their social media id/password, they may be prompted to enter this information prior to actually posting a message to the social media site. As shown in FIG. 5, the mobile application 200 includes a user interface 202 that is displayable on a display of the mobile communication device 102.

In one implementation, the user interface 202 is a generic user interface (or platform) that can be customized based on one or more special interest groups (SIG) that are affiliated with a user of the mobile communication device 102. In general, the user interface 202 can be customized to display, e.g., screens, logos, messages, maps, coupons, advertisements, and other information, as discussed in greater detail below. In one implementation, a special interest group (SIG) is an organization. For example, a special interest group can be members of a social network (i.e fans on Facebook, followers on twitter, followers on YouTube, friends on Linkedin, etc) a university, corporation, military, government, sports team, alumni association, and the like. These (and other SIGs) generally have a need to brand and customize mobile applications they either sponsor or associate their name to. Co-branding the mobile application with well-known third party brands will facilitate community exposure, help drive consumer acceptance and adoption through viral marketing (inherent to the community) as well as marketing programs by the SIG.

Usually, the format used by the mobile application 200 remains reasonably constant over time in contrast to content, which typically changes on a regular basis based on time and the SIG. In one implementation, as content changes on a regular basis, a SIG uploads only the new content to the management server (e.g., management server 180). Accordingly, when the mobile application 200 next accesses the content of the management server 180, the management server 180 uploads the new (customized SIG) content (and format if applicable) to the mobile application 200. Subsequent uploads to the mobile application 200 can include only content since the format, in one implementation, is cached on the mobile communication device 102 after the first download. If the SIG desires to change the format at a subsequent time, the next upload to the mobile application 200 can include both the new layout format and any new content. If applicable content is a coupon, ticket, or additional funds, the mobile wallet will transfer them to the secure element using methods described in previous patent filings which have been referenced previously in this specification.

FIG. 6 illustrates a method 300 for customizing a mobile application (e.g., mobile application 200) running on a mobile communication device. (e.g., mobile communication device 102). A mobile application having a generic platform is provided to a mobile communication device of a user (step 302). In one implementation, the mobile application is provided to the mobile communication device through a network—e.g., a public network (e.g., the Internet), a private network, or a voice communications network. The generic platform can comprise a generic user interface having default screens, controls, and/or logos. A determination is made (e.g., by management server 106) of one or more special interest groups (SIGs) that are associated with the user (step 304). In one implementation, the management server 306 queries a database (e.g., an affiliate content database) to determine which special interest groups (SIGs) that a given user is associated with. The generic platform of the mobile application is customized based on one or more of the special interest groups (SIGs) that are associated with the user (step 306).

In one implementation, association between a SIG and an end user is validated via an out-of-band process—e.g., a banking customer may have to specify their SIG and provide their SIG credentials (e.g., online banking userID/password) that are unique to the SIG. The management server validates the credentials with the SIG. Once the end user has been authenticated by the SIG, it will be possible to deliver the SIG's branding and messaging specifically to the end user. Such a technique minimizes the number of applications that need to be executed by a mobile communication device. For example, a single mobile application can be customized by a large number of different special interest groups (SIGs). In one implementation, the mobile application can be customized to display different screens, user interfaces and/or controls. Less memory is, therefore, required by a mobile communication device in order to support applications required by multiple special interest groups (SIGs)

To enable the branding and customization of the mobile application (e.g., the mobile wallet application) running on the mobile communication device 402, in one implementation, various screens are designed based on meta-data (i.e., meta-data delivered (pulled or pushed) to the mobile communication device 402 based on the SIG). The core wallet screen can be the same for all subscribers—e.g., a login screen for all subscribers can have the same pre-defined format (controlling how content is displayed and permitted actions), and only the content is dynamically generated. The following screens, or category of screens, include (but are not limited to):
Logo—A community logo will display upon wallet launch. If a customer is not affiliated with a SIG, the default Blaze logo will be displayed.
Watermark—An almost transparent watermark image that does not to conflict with maps, wallpaper, etc.
Advertisements—Local advertisements from the community will be displayed instead of or in addition to general advertisements. If a customer is not affiliated with a SIG, general advertisements will be displayed.
Coupons—Coupons from the local community will be displayed instead of or in addition to general coupons. If a customer is not affiliated with a SIG, general coupons will be displayed. The mobile wallet will transfer them to the secure element using methods described in previous patent filings which have been referenced previously in this specification.
Events—Community events will be displayed. If a customer is not affiliated with a SIG, general events will be displayed such as information about Blaze Mobiles new wallet features, etc.
Alerts—Community alerts will be displayed. If a customer is not affiliated with a SIG, general alerts will be displayed.
Maps—A map which shows the physical location of members of a SIG.

In some cases, a special interest group (SIG) may be involved in the content approval process. In such an implementation, in order to deliver meta-data to the mobile communication device based on input from the SIG, the end-user's account (e.g., walletID, etc.) is associated with a SIG. The SIG will access a portal (web-based or otherwise) (e.g., SIG portal 408) that enables the SIG to control, publish, etc., content associated to the SIG on the management server 404. In one implementation, one or more screens queries the management server 404 for dynamic content (media, text, logo, sort order, etc.). The query can include (but is not limited to) the end-users walletID. Using a look-up table in the management server 404 or the affiliate content database 412, it is possible to determine the associated SIG. The management server 404 can then internally determine the appropriate content (including media, etc.) to respond to the mobile application running on the mobile communication device 402. These result sets can be cached on the mobile communication device 402 for future use to improve performance (as needed).

Integrated Mobile Marketing Insertion In one implementation, an advertising manager application running on the management server 404 inserts advertisements (based on advertisement insertion order) into Ad Engine (or 3rdParty Ad Delivery platform). The advertising manager application specifies specific advertisements with targeting parameters of SIGs (among other targeting parameters as specified by, e.g., an advertising agency) and displays these ads in the mobile application

Integrated Mobile Marketing (Advertising and Coupons) Delivery In one implementation, advertising and/or coupons can be sent to a mobile application based on one or more special interest groups (SIGs) that a user is affiliated with. In one implementation, an end user registers affiliation with a special interest group (SIG) through a web portal (e.g., user portal 406). The management server 180 can validate the affiliation out-of-band. The end user logs into mobile application, and the mobile application queries the management server 404 for any advertisements or coupons by providing a screenID (a unique screen identifier). The management server 404 determines that the user has an affiliation to a special interest group (SIG) and appends the SIGID (a unique SIG identifier) to the target parameters. A query including the targeting parameters is forwarded to an advertising engine (or 3rdParty). The advertising engine responds with the appropriate URL to the advertising object that best meets the advertising criteria (e.g. age, gender, geographic location, proximity to retail store, shopping list, transaction history, etc). In one implementation, the mobile application queries advertisements based on the URL returned. FIG. 15 illustrates example advertisements/coupons that can be displayed through a mobile wallet application running on a mobile communication device.

Alerts and Notification In one implementation, alerts and notifications can be sent to a mobile application based on one or more special interest groups (SIGs) that a user is affiliated with. In one implementation, a notification manager application running on the management server 180 inserts alerts (based on an insertion order) into a notification engine associated with the management server 404 (or a third party notification delivery platform). The notification manager application associates the notifications (text, etc.) with one or more SIGIDs (among other targeting parameters as specified by, e.g., an advertising agency). In one implementation, the notification engine queries the user and profile database 410, and determines a list of walletIDs (of end users) that match the target delivery criteria. For each end-user identified, the management server 180 determines a notification mode (e.g., SMS/text messaging, e-mail, or both) and a delivery window (time of day, etc.). These criteria are used to send the notification (or alerts) to the end-user. FIG. 8 illustrates example alerts and notifications that can be displayed through a mobile application running on a mobile communication device.

SIG Location maps In one implementation, members of a SIG can see locations of other members on a map based on one or more special interest groups (SIGs) that a user is affiliated with. The users location is based on the GPS coordinates . In one implementation, and end user registers affiliation with a special interest group (SIG) through a web portal (e.g., user portal 406). The management server 180 can validate the affiliation of the user to the special interest group (SIG) out-of-band. The end user logs into the mobile application, and the mobile application queries the management server 180 for locations of all SIG members or certain members selected by the user.. The management server 180 determines the locations of the SIG members when SIG members login using the mobile wallet and elect to have their GPS coordinates uploaded to the management server. The management server responds to the query with a list of members of the special interest group (SIG) and displays them on a map with The map is cached in a memory of the mobile communication device 402, and the mobile application running on the mobile communication device 402 displays the SIG map.

One or more of method steps described above can be performed by one or more programmable processors executing a computer program to perform functions by operating on input data and generating output. Generally, the invention can take the form of an entirely hardware embodiment, an entirely software embodiment or an embodiment containing both hardware and software elements. In one implementation, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The method 500 thus allows for using a mobile communication's device and associated secure element to make purchases, transfer of transaction data to mobile wallet, posting transaction data from the mobile wallet n a social media site , and rewarding users for their marketing efforts. While the method 500 includes a number of operations that appear to occur in a specific order, it should be apparent that the method 500 can include more or fewer operations, which can be executed serially or in parallel. An order of two or more operations may be changed and two or more operations may be combined into a single operation.

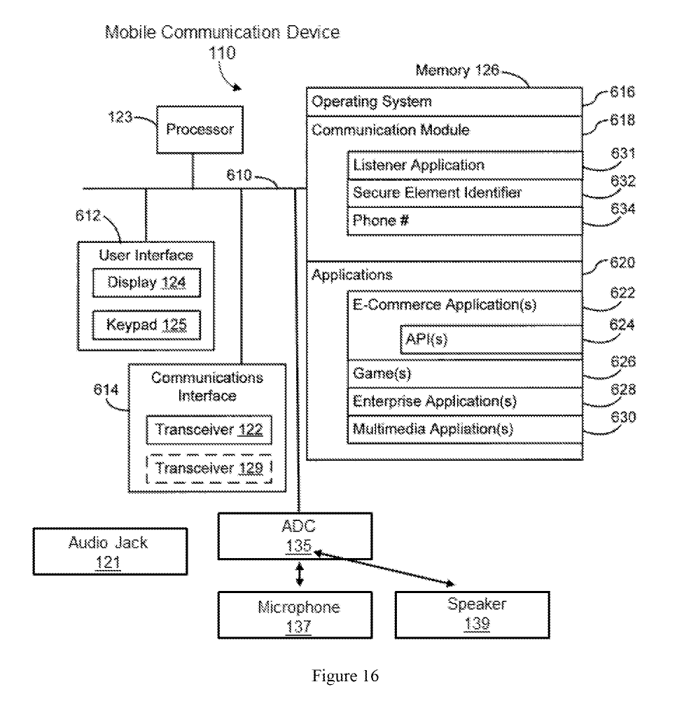

FIG. 16 is a block diagram illustrating a mobile communication device 110 (e.g., as shown in FIG. 2) in accordance with some embodiments. The device 110 includes a processor 123, one or more communications interfaces 614, memory 126, a user interface 612, and one or more communication buses 610 for interconnecting these components. The communication buses 610 may include circuitry that interconnects and controls communications between system components. The user interface 612 includes the display 124 and keypad 125. The communications interface 614 includes the transceiver 122 and, in some embodiments, the transceiver 129. The memory 126 includes high-speed random access memory, such as DRAM, SRAM, DDR RAM and/or other random access solid state memory devices; and includes non-volatile memory, such as flash memory devices, a magnetic disk storage device, and/or other non-volatile solid state storage devices. The memory 126, or alternately non-volatile memory device(s) within the memory 126, includes a non-transitory computer-readable storage medium. While the memory 126 is shown as being separate from the processor 123, all or a portion of the memory 126 may be embedded in the processor 123. In some embodiments, the memory 126 stores the following programs, modules and data structures, or a subset thereof:

an operating system 616 that includes procedures for handling various basic system services and for performing hardware dependent tasks;

a communication module 618 that is used for communicating with other devices (e.g., with the secure element 130 and the management server 180, FIG. 1) via the communications interface 614; and

applications 620, including one or more e-commerce applications 622 (e.g., ticketing applications; content, item and service purchase applications; and/or payment management applications), games 626, enterprise applications 628, and/or multimedia applications 630.

The communication module 618 also stores an identifier 632 of a secure element 130 that is physically coupled to the mobile communication device 110, for use in transmitting packets to the secure element 130, and the phone number 634 of the mobile communication device 110, for use in receiving messages from the secure element 130.

Associated with the e-commerce application(s) 622 are corresponding APIs for processing data received from other devices (e.g., the secure element 130 and the management server 180, FIG. 1) and data to be transmitted to the other devices. Similar APIs may be associated with the other applications 626, 628, and/or 630.

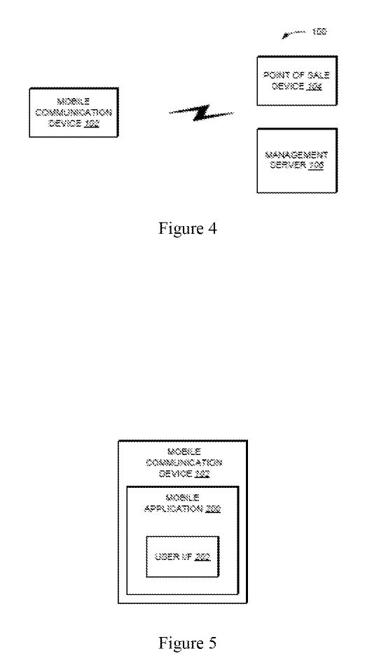

In some embodiments, the non-transitory computer-readable storage medium of the memory 126 includes instructions for performing all or a portion of the operations shown in the “mobile device communication 110” columns in FIGS. 4A-4D (except for the attaching operation 412, FIG. 4A). Likewise, the memory 126 includes instructions for performing all or a portion of the operations 504-512 in the method 500 (FIG. 8).

Each of the above identified elements in FIG. 3b may be stored in one or more of the previously mentioned memory devices in the memory 126. Each of the above identified modules corresponds to a set of instructions for performing functions described above. The above identified modules or programs (i.e., sets of instructions) need not be implemented as separate software programs, procedures or modules, and thus various subsets of these modules may be combined or otherwise re-arranged in various embodiments. In some embodiments, the memory 126 may store a subset of the modules and data structures identified above. Furthermore, the memory 126 may store additional modules and data structures not described above.

FIG. 3 is a block diagram illustrating a secure element 130 (e.g., as shown in FIGS. 3A-3E) in accordance with some embodiments. The secure element 130 includes a processor 132, one or more communications interfaces 714, memory 133, and one or more communication buses 710 for interconnecting these components. The communication buses 710 may include circuitry that interconnects and controls communications between components. The communications interface 714 includes the transceiver 134 and, in some embodiments, the transceiver 136. The memory 133 includes high-speed random access memory, such as DRAM, SRAM, DDR RAM and/or other random access solid state memory; and includes non-volatile memory, such as flash memory and/or other non-volatile storage. The memory 133, or alternately non-volatile memory within the memory 133, includes a non-transitory computer-readable storage medium. While the memory 133 is shown as being separate from the processor 132, all or a portion of the memory 133 may be embedded in the processor 132. In some embodiments, the memory 133 stores the following programs, modules and data structures, or a subset thereof:

an operating system 716 that includes procedures for handling various basic system services and for performing hardware dependent tasks;

a communication module 718 that is used for communicating with other devices (e.g., with the mobile communication device 110 and with POS and POE terminals 150, FIG. 1) via the communications interface 714; and

one or more applications 720 (e.g., e-commerce applications) and associated APIs 722.

The communication module 718 stores an identifier 724 of the secure element 130 (e.g., an identifier of the transceiver 134 or 136), for use in receiving packets from the mobile communication device 110 to which the secure element 130 is physically coupled, and also stores the phone number 726 and identifier 727 of the mobile communication device 110, for use in transmitting messages to the mobile communication device 110.

In some embodiments, the memory 133 includes instructions for performing all of the operations shown in the “secure element 130” columns in FIGS. 4A-4D (except for the attaching operation 412 and charging operation 414, FIG. 4A). Likewise, the memory 126 includes instructions for performing all or a portion of the operations 514-524 in the method 500 (FIG. 8).

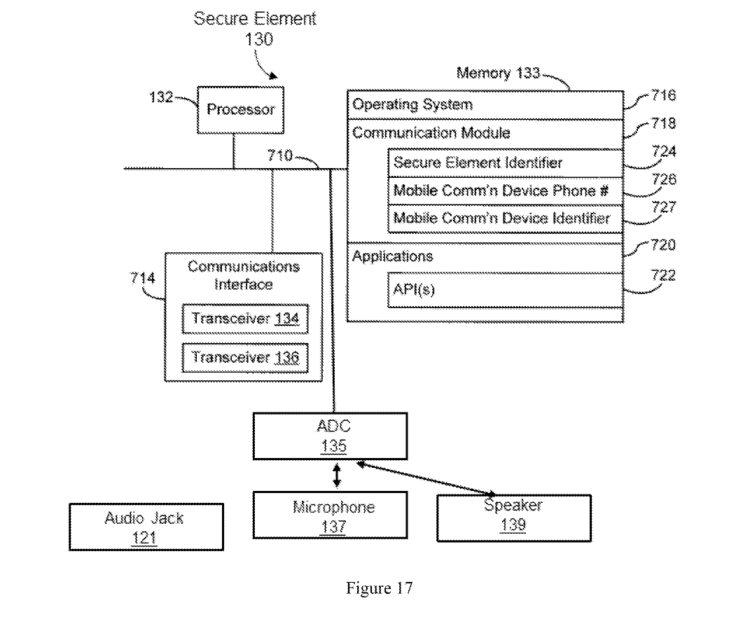

Each of the above identified elements in FIG. 17 may be stored in one or more of the previously mentioned components of the memory 133. Each of the above identified modules corresponds to a set of instructions for performing functions described above. The above identified modules or programs (i.e., sets of instructions) need not be implemented as separate software programs, procedures or modules, and thus various subsets of these modules may be combined or otherwise re-arranged in various embodiments. In some embodiments, the memory 133 may store a subset of the modules and data structures identified above. Furthermore, the memory 133 may store additional modules and data structures not described above.

The foregoing description, for purpose of explanation, has been described with reference to specific embodiments. However, the illustrative discussions above are not intended to be exhaustive or to limit the inventions to the precise forms disclosed. Many modifications and variations are possible in view of the above teachings. The embodiments were chosen and described in order to best explain the principles of the inventions and their practical applications, to thereby enable others skilled in the art to best utilize the inventions and various embodiments with various modifications as are suited to the particular use contemplated.

1. A method for conducting induction triggered transactions between a mobile communication device and a remote terminal, the method comprising:
executing an application on a processor of a secure element coupled to a mobile communication device, the secure element including:
a memory storing the application,
a processor that executes execute the application stored in the memory, and
a wireless transceiver that sends transaction data associated with the executed application through a second communication channel to a terminal that is remote from the mobile communication device, the second communication channel being different from a first communication channel through which the mobile communication device communicates voice data, the application executed in response to an induction-based trigger from the remote terminal;
wirelessly transmitting transaction data associated with the executed application through the second communication channel to the remote terminal using the wireless transceiver. storing at least a portion of the transaction data in memory accessible by the secure element;
opening the mobile wallet running on the mobile device which displays the transaction data and posting the transaction on a social media page .

2. The method of claim 1 where the transaction is posted “as is” which includes information about transaction such as the merchant name, merchant location, product ID, product name, cost, date of purchase, date of event, seat location, venue name, venue address, etc

3. The method of claim 1 where the transaction is modified with additional text, changes to the canned or “as is” text, deleting the canned text, add a picture, etc

4. The method of claim I where the user manually enters a user ID and password at the mobile wallet to unlock the mobile willet, whereby authentication is with a remote server.

5. The method of claim 1 where the user manually enters at the mobile wallet a user ID and password that is the same as their social media user id and password to unlock the mobile willet, whereby authentication is with a remote server.

6. The method of claim 1 where the management server calculates the compensation to reward the user for their post based on number of impressions (e.g. followers on twitter, fans on Facebook, etc.), number of previous posts by the user, significance of previous posts as measured by new posts generated or ratings by 3rd party systems such as Klout, location of purchase, merchant item was purchased by, transaction amount, payment method (e.g. using NFC, SMS, WAP, traditional card), previous transaction history, number of new posts generated by the post (e.g. “Retweets”), etc.

7. The method of claim 6 where the user receives a digital artifact as compensation for their post at the mobile device

8. The method of claim 6 where the user receives a digital artifact as compensation for their post at the secure element associated with the mobile device.

9. the method of claim 7 where the compensation can include a digital artifact which includes but not limited to debit/prepaid/credit card, receipts, tickets, advertisements, coupons, loyalty points, gift cards, vouchers, content (video, image, ringtone, movie), games, documentation, etc.

10. The method of claim 8 where the compensation can include a digital artifact which includes but not limited to debit/prepaid/credit card, receipts, tickets, advertisements, coupons, loyalty points, gift cards, vouchers, content (video, image, ringtone, movie), games, documentation, etc

11. The method of claim 6 where the remote server unlocks the secure element prior to transmission of the digital artifact.

12. The method of claim 6 where the remote server downloads an encrypted file containing the secure element key whereby the mobile wallet decrypts the file and uses the secure element key to unlock secure element prior to transmission of the digital artifact.

13. The method of claim 1 where post to social media site is subsequently displayed on another medium

14. The method of claim 13 where the medium is television.

15. The method of claim 13 where the medium is a newspaper, magazine, or some other printed medium.

16. The method of claim 13 where the medium is a poster or billboard.

17. The method of claim 13 where the medium is a smart poster.

18. The method of claim 13 where the medium is a website.

19. The method of claim 13 where the medium is clothing.

20. The method where the user posts a transaction on a social media site using the mobile wallet whereby the transaction is from a purchase using SMS, WAP, magnetic stripe card, online purchase, etc.
